(19) United States
(12) Patent Application Publication
(10) Pub. No.: US 2017/0154423 A1
(43) Pub. Date: Jun. 1, 2017

(54) METHOD AND APPARATUS FOR ALIGNING OBJECT IN IMAGE

(71) Applicant: Samsung Electronics Co., Ltd., Suwon-si (KR)

(72) Inventors: Jingu HEO, Yongin-si (KR); Dong Kyung NAM, Yongin-si (KR)

(73) Assignee: Samsung Electronics Co., Ltd., Suwon-si (KR)

(21) Appl. No.: 15/203,349

(22) Filed: Jul. 6, 2016

(30) Foreign Application Priority Data
Nov. 30, 2015 (KR) 10-2015-0168688

(51) Int. Cl. G06T 7/00; G06K 9/62; G06K 9/66

(52) U.S. Cl. CPC G06T 7/0024; G06T 7/0002; G06K 9/66; G06K 9/6267; G06K 9/6256; G06T 2207/30168; G06T 2200/04

(57) ABSTRACT

An object aligning method may include aligning an object in an input image corresponding to a quality of the input image.

### CROSS-REFERENCE TO RELATED APPLICATION

This application claims under 35 U.S.C. §119 to Korean Patent Application No. 10-2015-0168688, filed on Nov. 30, 2015, at the Korean Intellectual Property Office, the entire contents of which are incorporated herein by reference in its entirety.

### BACKGROUND

1. Field

At least one example embodiment relates to a method and/or an apparatus for aligning an object in an image.

2. Description of the Related Art

Desired information may be obtained from an image by detecting an object in the image and aligning the detected object. For example, by detecting and aligning an object, an eye position of a user may be obtained from an image and a corresponding three-dimensional (3D) image may be generated based on the eye position of the user. Object detecting refers to a scheme for identifying a position of an object in an image, and object aligning refers to a scheme for extracting a feature point of the object to represent a form of the object detected from the image using dots and lines. Object aligning may also refer to a scheme for determining a pose or a shape of an object to be specifically represented at a position at which the object is detected. For example, a pose or facial expression of the user may be recognized based on the object aligning result.

### SUMMARY

At least one example embodiment relates to an object aligning method.

According to an example embodiment, the object aligning method may include determining a quality of an input image, and aligning an object in the input image using an aligner corresponding to the quality of the input image.

Example embodiments provide that the quality of the input image may indicate a difficulty level at which the aligner aligns the input image. Example embodiments provide that the quality of the input image may be determined based on any one of a high quality of which an alignment difficulty level is lower than a first reference value, a medium quality of which the alignment difficulty level is between the first reference value and a second reference value, and a low quality of which the alignment difficulty level is higher than the second reference value.

Example embodiments provide that the determining may include determining the quality of the input image using a quality classifier learning images of various qualities. Example embodiments provide that the determining may include determining the quality of the input image using a quality classifier including a first classifier learning images of high quality, a second classifier learning images of medium quality, and a third classifier learning images of low quality. Example embodiments provide that the first classifier may be trained based on a training sample in which the images of high quality are included in a positive class, and the images of medium quality and the images of low quality are included in a negative class.

Example embodiments provide that the aligner may be trained based on a training sample corresponding to the quality of the input image. Example embodiments provide that the aligning may include aligning the object using the aligner corresponding to the quality of the input image among a first aligner corresponding to a high quality, a second aligner corresponding to a medium quality, and a third aligner corresponding to a low quality. Example embodiments provide that the first aligner may be trained based on a training sample of high quality, the second aligner is trained based on a training sample of medium quality, and the third aligner is trained based on a training sample of low quality.

At least one example embodiment relates to an object aligning apparatus.

According to another example embodiment, the object aligning apparatus may include a quality determiner configured to determine a quality of an input image, and an aligner configured to align an object in the input image, the aligner corresponding to the quality of the input image.

At least one example embodiment relates to a training method.

According to still another example embodiment, the training method may include determining a quality of a training sample, and training an aligner corresponding to the quality of the training sample.

Example embodiments provide that the quality of the training sample may indicate a difficulty level at which the aligner aligns the training sample. Example embodiments provide that the determining may include determining the quality of the training sample based on an error rate occurring when the training sample is aligned by a pre-trained test aligner. Example embodiments provide that the determining may include determining the quality of the training sample based on any one of a high quality of which an alignment difficulty level is lower than a first reference value, a medium quality of which the alignment difficulty level is between the first reference value and a second reference value, and a low quality of which the alignment difficulty level is higher than the second reference value.

Example embodiments provide that the training may include training the aligner corresponding to the quality of the training sample among a first aligner corresponding to a high quality, a second aligner corresponding to a medium quality, and a third aligner corresponding to a low quality.

Example embodiments provide that the training method may further include aligning, by the first aligner, a training sample of medium quality and a training sample of low quality, and changing, to high quality, a training sample having a high alignment accuracy among the training sample of medium quality and the training sample of low quality. Example embodiments provide that the training method may further include training a quality classifier for determining a quality of an input image based on the training sample, wherein the quality classifier may include a first classifier learning images of high quality, a second classifier learning images of medium quality, and a third classifier learning images of low quality.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a block diagram illustrating an example of an object aligning apparatus according to at least one example embodiment;

FIG. 2 is a block diagram illustrating an example of an object aligner according to at least one example embodiment;

FIG. 3 is a block diagram illustrating an example of a quality classifier according to at least one example embodiment;

FIG. 4 is a block diagram illustrating an example of a trainer to train a quality classifier and an object aligner according to at least one example embodiment;

FIG. 5 is a block diagram illustrating an example of a training process of an object aligner according to at least one example embodiment;

FIG. 6 illustrates an example of a classifying process of a training sample according to at least one example embodiment;

FIG. 7 is a block diagram illustrating an example of a training process of a quality classifier according to at least one example embodiment;

FIG. 8 illustrates examples of an image of high quality and an image of low quality according to at least one example embodiment;

FIG. 9 is a flowchart illustrating an example of an object aligning method according to at least one example embodiment; and

FIG. 10 is a flowchart illustrating an example of a training method according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

Hereinafter, reference will now be made in detail to embodiments, examples of which are illustrated in the accompanying drawings, wherein like reference numerals refer to like elements throughout. The following example embodiments may be used to detect a desired (or alternatively, predetermined) object in an input image. For example, example embodiments may be used to determine an eye position of a user for generating a three-dimensional (3D) image.

FIG. 1 is a block diagram illustrating an example of an object aligning apparatus according to at least one example embodiment. Referring to FIG. 1, an object aligning apparatus 100 includes a quality calculator 110 and an object aligner 120. The object aligning apparatus 100 may generate alignment information based on an input image. The object aligning apparatus 100 may obtain desired information from an image by aligning an object in the input image. In an example, the object aligning apparatus 100 may receive detection information on the object from an object detecting apparatus (not shown). The object aligning apparatus 100 may align the object in the input image based on the detection information. The object aligning apparatus 100 may generate alignment information based on an aligning result of the object. For example, the alignment information may be used to represent an eye position of a user in the input image, and a corresponding 3D image may be generated based on the eye position of the user. Object detecting refers to identifying a position of the object in the image. Object aligning refers to extracting a feature point of the object to represent a form of the object detected from the image using dots and lines. The alignment information may include information on the feature point for representing the form of the object using dots and lines. A pose of the object and the form of the object may be determined based on the object aligning result. For example, a pose or facial expression may be recognized based on the object aligning result.

It should be understood that the object alignment apparatus 100 and elements thereof may be implemented as a processor (e.g., a special purpose processor) executing instructions stored on a memory associated with the processor.

The quality calculator 110 may determine a quality of the input image. In an example, the quality may be an implicit quality. Implicit quality refers to a concept different from that of explicit quality. Explicit quality refers to a quality determined based on a visual reference of the user. For example, the explicit quality may be determined by the user, based on a visually determinable reference such as resolution, sharpness, distortion, saturation, brightness, and an artifact. Implicit quality refers to a quality determined based on an experimental reference of a classifier or an aligner. For example, the implicit quality may be determined based on a ground-truth error of the feature point, a shape of an eye, a pose of the user, and a bounding box issue of a detector. Even when the user is explicitly observed, an image of which a feature point is detected by the aligner with difficulty may correspond to an image of which the implicit quality is low. Thus, the implicit quality indicates a difficulty level at which the object aligner 120 aligns the input image. As will be described in detail below, example embodiments may determine the quality of the input image and increase accuracy of alignment by aligning the input image for each quality. For example, an aligner trained by a training sample of a desired (or alternatively, predetermined) quality may align an input image of desired (or alternatively, predetermined) quality in more detail compared to an aligner trained by training samples of various qualities. Thus, example embodiments may provide a method of providing training samples for each quality and a method of training aligners for each quality.

The quality calculator 110 may calculate the quality of the input image using a desired (or alternatively, pre-trained) quality classifier. Example embodiments will be described with respect to three qualities, however, they may be similarly applied with respect to two qualities or at least four qualities. The quality classifier may learn training samples for each quality to classify a quality of a desired (or alternatively, predetermined) image. Related descriptions of the quality classifier will be provided.

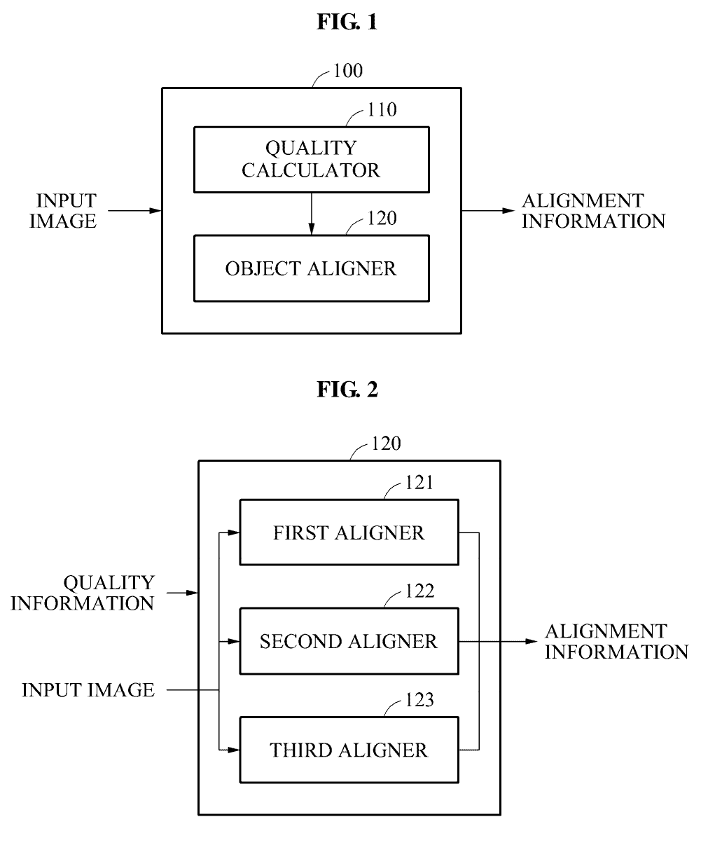

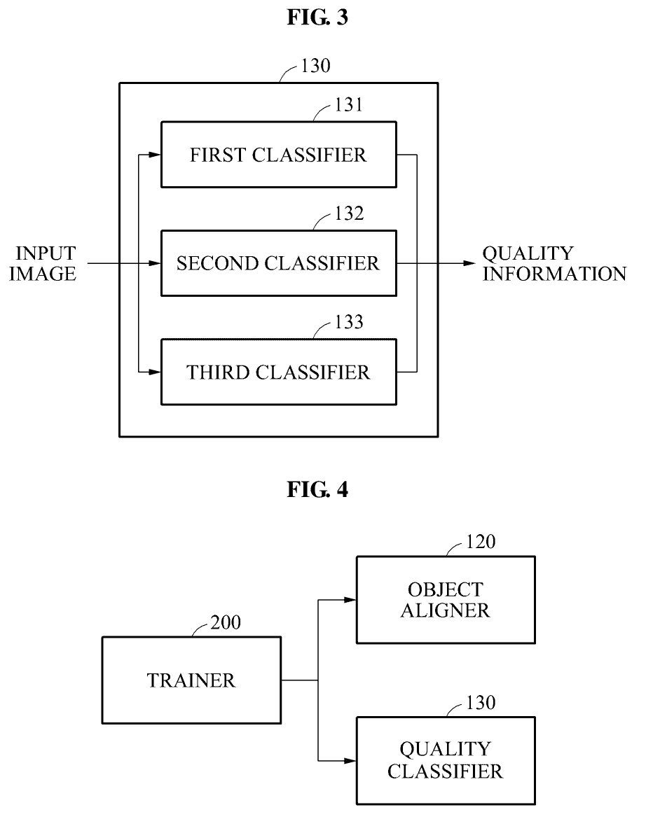

The object aligner 120 may align the object in the input image. The object aligner 120 may align the object based on an active shape model (ASM), an active appearance model (AAM), and a supervised descent method (SDM). The object aligner 120 may include a plurality of aligners. The object aligner 120 may align the object in the input image using an aligner corresponding to the quality of the input image among the plurality of aligners. The object aligner 120 may generate and output the alignment information based on the aligning result. The object aligner 120 may receive the detection information on the object from the object detecting apparatus (not shown). The object aligner 120 may align the object in the input image based on the detection information. For example, the object detecting apparatus (not shown) may detect an eye, a nose, and a mouth in the input image of a face of the user. The object detecting apparatus (not shown) may generate the detection information on positions of the eye, the nose, and the mouth. The object aligner 120 may align the eye, the nose, and the mouth in the input image based on the detection information on the positions of the eye, the nose, and the mouth. For example, the object aligner 120 may detect feature points of the eye, the nose, and the mouth to represent the eye, the nose, and the mouth in the input image using dots and lines. The object aligner 120 may generate and output the alignment information based on the detected feature points. Related descriptions of the object aligner 120 will be provided with reference to FIG. 2.

FIG. 2 is a block diagram illustrating an example of an object aligner according to at least one example embodiment. The object aligner 120 includes a first aligner 121, a second aligner 122, and a third aligner 123. Although the object aligner 120 will be described as including three aligners 121, 122, and 123, the object aligner 120 may include two aligners or at least four aligners.

As described above, the object aligner 120 includes the first aligner 121, the second aligner 122, and the third aligner 123 trained for each quality. For example, the first aligner 121 may correspond to a high quality, the second aligner 122 may correspond to a medium quality, and the third aligner 123 may correspond to a low quality. The first aligner 121 may be trained based on a training sample of high quality, the second aligner 122 may be trained based on a training sample of medium quality, and the third aligner 123 may be trained based on a training sample of low quality.

An input image or a training sample may be classified as high-quality when an alignment difficulty level is lower than a first reference value. The input image or the training sample may be classified as medium-quality when the alignment difficulty level is between the first reference value and a second reference value. The input image or the training sample may be classified as low-quality when the alignment difficulty level is higher than the second reference value. The alignment difficulty level may be determined based on an error rate occurring when alignment is performed. For example, from a desired (or alternatively) predetermined image it may be determined that the alignment difficulty level is relatively high in response to a great error rate occurring when the desired (or alternatively, predetermined) image is aligned.

The object aligner 120 may transmit the input image to any one of the first aligner 121, the second aligner 122, and the third aligner 123 based on quality information. The object aligner 120 may align an object in the input image using an aligner corresponding to the quality information among the first aligner 121, the second aligner 122, and the third aligner 123. For example, when the input image is identified to be high-quality based on the quality information, the object aligner 120 may align the object using the first aligner 121 corresponding to high quality.

FIG. 3 is a block diagram illustrating an example of a quality classifier according to at least one example embodiment. Referring to FIG. 3, a quality classifier 130 includes a first classifier 131, a second classifier 132, and a third classifier 133. As described above, a quality calculator may calculate a quality of an input image using the quality classifier 130. Although the quality classifier 130 will be described as including three classifiers 131, 132, and 133, the quality classifier 130 may include one classifier, two classifiers, or at least four classifiers.

Each of the first classifier 131, the second classifier 132, and the third classifier 133 may receive an input image. Each of the first classifier 131, the second classifier 132, and the third classifier 133 may generate and output quality information. Each of the first classifier 131, the second classifier 132, and the third classifier 133 may learn any one quality and generate the quality information corresponding to the any one quality. For example, the first classifier 131 may learn an image of high quality, detect the image of high quality among input images, and generate alignment information corresponding to the image of high quality.

As will be described in detail below, the first classifier 131 may learn a training sample in which images of high quality are included in a positive class, and images of medium quality and images of low quality are included in a negative class. The second classifier 132 may learn a training sample in which the images of medium quality are included in the positive class, and the images of high quality and the images of low quality are included in the negative class. The third classifier 133 may learn a training sample in which the images of low quality are included in the positive class, and the images of high quality and the images of medium quality are included in the negative class.

An image of high quality may be detected by the first classifier 131, an image of medium quality may be detected by the second classifier 132, and an image of low quality may be detected by the third classifier 133. The input images may be input in parallel or in sequence to the first classifier 131, the second classifier 132, and the third classifier 133. When the first classifier 131 detects the image of high quality among the input images, the quality information corresponding to the high quality may be generated. Similarly, when the second classifier 132 detects the image of medium quality among the input images, the quality information corresponding to the medium quality may be generated. When the third classifier 133 detects the image of low quality among the input images, the quality information corresponding to the low quality may be generated.

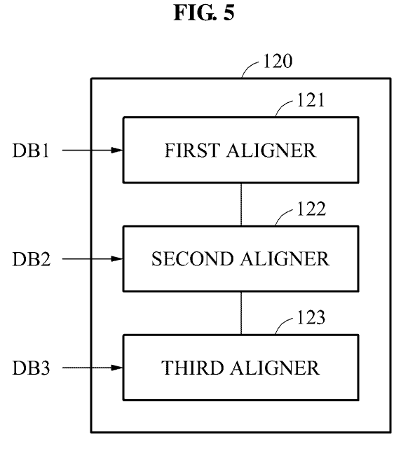

FIG. 4 is a block diagram illustrating an example of a trainer to train a quality classifier and an object aligner according to at least one example embodiment. Referring to FIG. 4, a trainer 200 trains the quality classifier 130 and the object aligner 120. The trainer 200 may train the quality classifier 130 and the object aligner 120 based on various machine learning methods. The trainer 200 may train the quality classifier 130 and the object aligner 120 based on a number of training samples. The trainer 200 may adjust a parameter of the quality classifier 130 and the object aligner 120 based on a training result. For example, the trainer 200 may adjust the parameter of the quality classifier 130 to detect a positive class in a training sample. Detailed descriptions of a training process of the object aligner 120 and the quality classifier 130 will be provided with reference to FIGS. 5 through 7.

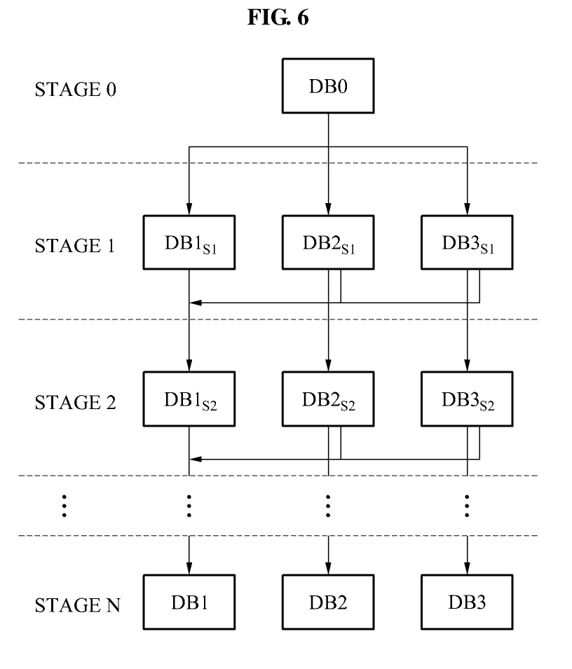

FIG. 5 is a block diagram illustrating an example of a training process of an object aligner according to at least one example embodiment. Referring to FIG. 5, the object aligner 120 includes the first aligner 121, the second aligner 122, and the third aligner 123. The object aligner 120 may be trained by a trainer. The first aligner 121 may learn a training sample DB1. The second aligner 122 may learn a training sample DB2, and the third aligner 123 may learn a training sample DB3. Each of the training samples DB1, DB2, and DB3 may include images of different qualities. For example, the training sample DB1 may include images of high quality. The training sample DB2 may include images of medium quality, and the training sample DB3 may include images of low quality. The training samples DB1, DB2, and DB3 may be classified based on an alignment error rate. Detailed descriptions of a classifying process of the training samples DB1, DB2, and DB3 will be provided with reference to FIG. 6.

FIG. 6 illustrates an example of a classifying process of a training sample according to at least one example embodiment. Training samples may be classified through a number of stages.

At stage 0, a training sample DB0 may be classified as training samples DB1S1, DB2S1, and DB3S1 associated with a plurality of qualities by a default aligner. The default aligner may be trained based on various qualities. The default aligner may be an aligner trained regardless of a quality of a training sample. For example, the default aligner may be trained by the training sample DB0 including images of various qualities.

The default aligner may align the training sample DB0 and generate alignment information. The default aligner may align an object based on an active shape model (ASM), an active appearance model (AAM), and a supervised descent method (SDM). The alignment information may include an error according to performance of the default aligner. Although the error may be defined based on various references, the error may be defined below based on a distance between a position of an actual feature point and a position of a feature point by the alignment information generated by the default aligner. Thus, an alignment error rate of the default aligner related to a desired (or alternatively, predetermined) training sample may increase according to an increase in a distance between an actual position of a feature point by validation data and a position of a feature point by the alignment information generated by the default aligner.

A training sample of which the alignment error rate is great refers to a sample of which an alignment difficulty level is high, and a training sample of which the alignment error rate is small refers to a sample of which the alignment difficulty level is low. Based on a definition of the aforementioned implicit quality, a training sample of which the alignment error rate is great indicates that a quality of an image is low, and a training sample of which the alignment error rate is small indicates that the quality of the image is high. For example, a training sample of which the alignment difficulty level is lower than a first reference may be determined to have a high quality, and a training sample of which the alignment difficulty level is between the first reference value and a second reference value may be determined to have a medium quality, and a training sample of which the alignment difficulty level is higher than the second reference value may be determined to have a low quality. At stage 0, the training sample DB0 may be classified, by the default aligner, as the training sample DB1S1 of high quality, the training sample DB2S1 of medium quality, and the training sample DB3S1 of low quality. A training sample DB1Sn, a training sample DB2Sn, and a training sample DB3Sn may correspond to a high quality, a medium quality, and a low quality, respectively. Here, n denotes a natural number greater than or equal to 1.

At stage 1 and stage 2, an aligner may be trained and training samples may be adjusted. At stage 1, a first aligner may learn the training sample DB1S1. A second aligner may learn the training sample DB2S1 and a third aligner may learn the training sample DB3S1. At stage 1, the second aligner may learn the training sample DB2S1 and then test the training sample DB2S1. At least one sample classified as the training sample DB2S1 according to the alignment error rate may be classified as the training sample DB1S1. For example, based on a test result of the second aligner related to a desired (or alternatively, predetermined) sample included in the training sample DB2S1 that the alignment error rate is less than the first reference value, the desired (or alternatively, predetermined) sample may be classified as the training sample DB1S1.

At stage 1, the third aligner may learn the training sample DB3S1 and then test the training sample DB3S1. At least one sample classified as the training sample DB3S1 according to the alignment error rate may be classified as the training sample DB1S1 and the training sample DB2S1. For example, based on a test result of the third aligner related to a desired (or alternatively, predetermined) sample included in the training sample DB3S1 that the alignment error rate is less than the first reference value, the desired (or alternatively, predetermined) sample may be classified as the training sample DB1S1. Based on the test result of the third aligner related to the desired (or alternatively, predetermined) sample included in the training sample DB3S1 that the alignment error rate is greater than the first reference value and less than the second reference value, the desired (or alternatively, predetermined) sample may be classified as the training sample DB2S1.

At stage 2, the aligner may be trained and the training samples may be adjusted in a way similar to the way they were adjusted at stage 1. Each of the first aligner, the second aligner, and the third aligner may learn a training sample DB1S2, a training sample DB2S2, a training sample DB3S2. Based on the test results of the second aligner and the third aligner, the training samples DB1S2, DB2S2, and DB3S2 may be adjusted.

At stage N, training samples DB1, DB2, and DB3 may be determined. At stage N−1, based on the test results of the second aligner and the third aligner that the training samples DB1S(n−1), DB2S(n−1), and DB3S(n−1) have not been further adjusted, the training samples DB1, DB2, and DB3 may be determined. Each of the first aligner, the second aligner, and the third aligner may learn the training samples DB1, DB2, and DB3 at stage N, such that each of the first aligner, the second aligner, and the third aligner may be determined.

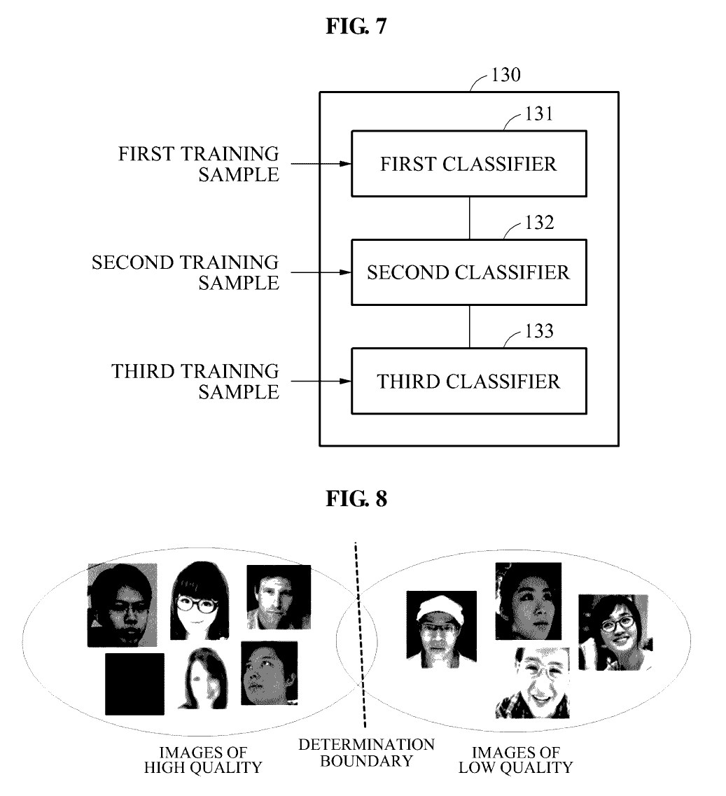

FIG. 7 is a block diagram illustrating an example of a training process of a quality classifier according to at least one example embodiment. Referring to FIG. 7, the quality classifier 130 includes the first classifier 131, the second classifier 132, and the third classifier 133. The first classifier 131 may learn a first training sample. The second classifier 132 may learn a second training sample, and the third classifier 133 may learn a third training sample. Each of the first training sample, the second training sample, and the third training sample may include samples for learning images of different qualities. For example, the first training sample may include a sample for learning an image of high quality. The second training sample may include a sample for learning an image of medium quality, and the third training sample may include a sample for learning an image of low quality.

In an example, in the first training sample, a positive class may include images of high quality, and a negative class may include images of medium quality and images of low quality. In the second training sample, the positive class may include the images of medium quality, and the negative class may include the images of high quality and the images of low quality. In the third training sample, the positive class may include the images of low quality and the negative class may include the images of high quality and the images of medium quality. Thus, the first classifier 131 may detect an image of high quality in an input image, the second classifier 132 may detect an image of medium quality in the input image, and the third classifier 133 may detect an image of low quality in the input image.

FIG. 8 illustrates examples of an image of high quality and an image of low quality according to at least one example embodiment. FIG. 8 illustrates examples of images of high quality and images of low quality when objects to be aligned are eyes of users. As described above, a quality of an example refers to an implicit quality. Implicit quality refers to a quality based on an experimental reference of a classifier or an aligner, and the implicit quality may be determined based on a ground-truth error of a feature point, a shape of an eye, a pose of a user, and a bounding box issue of a detector.

As illustrated in FIG. 8, an image clearly observed by a user may correspond to an image of low quality when a feature point is with difficulty detected by an aligner. For example, the image of low quality may include an image of a user of which an eye shape is unusual or an image of a user of which an eye shape is not clear because the user wears glasses. Even when a brightness of an image is relatively dark or vague, the image may be classified as an image of high quality when alignment is easily performed by the aligner. Although the images corresponding to two qualities are illustrated in FIG. 8, an image of medium quality may exist between the image of high quality and the image of low quality. Also, a quality may be classified as two qualities or at least four qualities. In a training process of the aforementioned classifier, it is understood that a determination boundary of FIG. 8 may be learned.

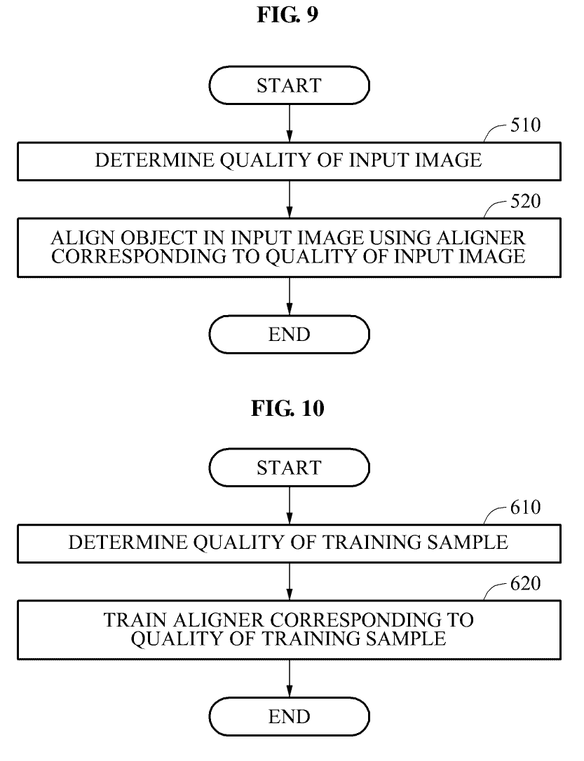

FIG. 9 is a flowchart illustrating an example of an object aligning method according to at least one example embodiment. In operation 510, an object aligning apparatus determines a quality of an input image. In operation 520, the object aligning apparatus aligns an object in an input image using an aligner corresponding to the quality of the input image.

FIG. 10 is a flowchart illustrating an example of a training method according to at least one example embodiment. In operation 610, a training apparatus determines a quality of a training sample. In operation 620, the training apparatus trains an aligner corresponding to the quality of the training sample.

From the above description, it should be understand that example embodiments may be used to detect a desired (or alternatively, predetermined) object in an input image. For example, example embodiments may be used to determine an eye position of a user. The eye position may be used for generating a three-dimensional (3D) image. Further, example embodiments may determine the quality of the input image and increase accuracy of alignment by aligning the input image for each quality.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor (e.g., special purpose processor), a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An object aligning method comprising:
determining a quality of an input image; and
aligning an object in the input image corresponding to the quality of the input image.

2. The method of claim 1, wherein the quality of the input image indicates a difficulty level for aligning the input image.

3. The method of claim 1, wherein the determining the quality of the input image is based on any one of a high quality in which an alignment difficulty level is lower than a first reference value, a medium quality in which the alignment difficulty level is between the first reference value and a second reference value, and a low quality in which the alignment difficulty level is higher than the second reference value.

4. The method of claim 1, wherein the determining comprises determining the quality of the input image by learning images of various qualities.

5. The method of claim 1, wherein the determining comprises determining the quality of the input image by learning images of high quality, learning images of medium quality, and learning images of low quality.

6. The method of claim 5, wherein the learning images of high quality is based on a training sample in which the images of high quality are comprised in a positive class, and the images of medium quality and the images of low quality are comprised in a negative class.

7. The method of claim 1, wherein the aligning is performed based on a training sample corresponding to the quality of the input image.

8. The method of claim 1, wherein the aligning comprises aligning the object corresponding to the quality of the input image from among a first alignment operation corresponding to a high quality, a second alignment operation corresponding to a medium quality, and a third alignment operation corresponding to a low quality.

9. The method of claim 8, wherein the first alignment operation is trained based on a training sample of high quality, the second alignment operation is trained based on a training sample of medium quality, and the third alignment operation is trained based on a training sample of low quality.

10. A non-transitory computer-readable medium comprising program code that, when executed by a processor, causes the processor to perform functions according to the method of claim 1.

11. An object aligning apparatus comprising:
a processor; and
a memory including instructions, which when executed by the processor, cause the processor to,
determine a quality of an input image, and
align an object in the input image, the aligner corresponding to the quality of the input image.

12. The apparatus of claim 11, wherein the quality of the input image indicates a difficulty level for aligning the input image.

13. The apparatus of claim 11, wherein the aligner is trained based on a training sample corresponding to the quality of the input image.

14. A training method comprising:
determining a quality of a training sample; and
performing a training operation corresponding to the quality of the training sample.

15. The method of claim 14, wherein the quality of the training sample indicates a difficulty level for aligning the training sample.

16. The method of claim 14, wherein the determining comprises determining the quality of the training sample based on an error rate occurring when the training sample is aligned by a pre-trained test operation.

17. The method of claim 14, wherein the determining comprises determining the quality of the training sample based on any one of a high quality in which an alignment difficulty level is lower than a first reference value, a medium quality in which the alignment difficulty level is between the first reference value and a second reference value, and a low quality in which the alignment difficulty level is higher than the second reference value.

18. The method of claim 14, wherein the training comprises training corresponding to the quality of the training sample from among a first alignment operation corresponding to a high quality, a second alignment operation corresponding to a medium quality, and a third alignment operation corresponding to a low quality.

19. The method of claim 18, further comprising:
aligning, by the first alignment operation, a training sample of medium quality and a training sample of low quality; and
changing, to high quality, a training sample having a high alignment accuracy among the training sample of medium quality and the training sample of low quality.

20. The method of claim 14, further comprising:
training a quality classifier for determining a quality of an input image based on the training sample,
wherein the quality classifier comprises a first classifier learning images of high quality, a second classifier learning images of medium quality, and a third classifier learning images of low quality.
